(19) United States
(12) Patent Application Publication
(10) Pub. No.: US 2019/0365115 A1
(43) Pub. Date: Dec. 5, 2019

(54) Micro-Circulation Breathable Cushion

(71) Applicant: HANGZHOU SHINNWA HOMETEX CO., LTD, Hangzhou (CN)

(72) Inventor: Jianguo Wu, Hangzhou (CN)

(21) Appl. No.: 16/120,340

(22) Filed: Sep. 3, 2018

(30) Foreign Application Priority Data
May 31, 2018 (CN) 201810551341.6

(51) Int. Cl. A47C 27/00; A47C 31/10; A47C 31/11

(52) U.S. Cl. CPC A47C 27/001; A47C 31/105; A47C 31/11; B32B 3/266; B32B 2307/72; B32B 2307/724; A47C 27/002

(57) ABSTRACT

A micro-circulation breathable cushion includes a cushion cover and a cushion core. The cushion core includes a breathable layer. At least one micro-circulation layer is disposed at a lower part of the breathable layer. The micro-circulation layer is connected to the breathable layer. The cushion cover wraps the cushion core, the breathable layer and the micro-circulation layer of the cushion core may be fixed together by glue or other manners, and may also be laminated together, thereby facilitating the replacement of different numbers of micro-circulation layers. The breathable layer may be directly washed, and an air micro-circulation is formed through an internal structure. An air micro-circulation may be likewise formed through an internal structure of the layer, and the breathable layer and the micro-circulation layer may co-form an air micro-circulation, thus increasing the breathability of the cushion core. Furthermore, different numbers of micro-circulation layers may be according to different temperatures.

### CROSS REFERENCE TO RELATED APPLICATION

The present application claims the priority of Chinese patent application No. 201810551341.6 filed on May 31, 2018, the entire contents of which are hereby incorporated by reference.

### TECHNICAL FIELD

The present invention relates to the field of daily supplies, and more particularly relates to a micro-circulation breathable cushion.

### BACKGROUND ART

Currently, a cushion is cushioned on an object and also used to support the object, such as a sofa cushion, a mattress, a chair cushion, an automobile seat cushion, and a tent cushion. The existing cushion is bad in breathability, easily causes sweating in summer, and is difficult to clean.

### SUMMARY OF THE INVENTION

With the view of solving the foregoing existing problem, the present invention provides a micro-circulation breathable cushion.

In view of this, the present invention adopts the technical scheme as follows. A micro-circulation breathable cushion is characterized by including a cushion cover and a cushion core. The cushion core includes a breathable layer. At least one micro-circulation layer is disposed at a lower part of the breathable layer. The micro-circulation layer is connected to the breathable layer. The cushion cover wraps the cushion core, the breathable layer may be directly washed, and an air micro-circulation is formed through an internal structure. An air micro-circulation may be likewise formed through an internal structure of the micro-circulation layer, and the breathable layer and the micro-circulation layer may co-form an air micro-circulation, thus increasing the breathability of the cushion core. Furthermore, different numbers of micro-circulation layers may be selected according to the requirements of different people, and different numbers of micro-circulation layers may also be selected according to different temperatures.

Alternatively, the density of the breathable layer is in a range of 25 Kg/m³ to 85 Kg/m³.

The density of the breathable layer is controlled to be in a range of 25 Kg/m³ to 85 Kg/m³, so that the breathable layer can be directly washed and may be kept super-breathable.

Alternatively, the aperture of an internal hole of the micro-circulation layer is in a range of 10 ppi to 60 ppi.

Alternatively, the density of the micro-circulation layer is in a range of 0.02 g/cm³ to 0.035 g/cm³.

The aperture of the internal hole of the micro-circulation layer is kept in a range of 10 ppi to 60 ppi, and the density of the micro-circulation layer is in a range of 0.02 g/cm³ to 0.035 g/cm³, so that the micro-circulation layer can be directly washed and is super-breathable.

Alternatively, the micro-circulation layer is fixedly connected to the breathable layer.

Alternatively, the micro-circulation layer is movably connected to the breathable layer.

The breathable layer and the micro-circulation layer of the cushion core may be fixed together by glue or other manners, and may also be only laminated together, thereby facilitating the replacement of different numbers of micro-circulation layers.

Alternatively, a base layer is disposed below the micro-circulation layer, the base layer being fixedly connected to the micro-circulation layer.

Alternatively, a base layer is disposed below the micro-circulation layer, the base layer being movably connected to the micro-circulation layer.

Compared with the breathable layer and the micro-circulation layer, the base layer is harder for supporting. Furthermore, the base layer and the micro-circulation layer may be fixed together by glue or other manners, and may also be only laminated together, thereby facilitating the replacement of different numbers of micro-circulation layers, and also making it convenient for a user to use the base layer or not.

Alternatively, the cushion cover is made of a fiber material with a mesh structure. The cushion cover of the cushion, made of the fiber material with the mesh structure, is good in breathability and easy to clean.

Alternatively, a zipper is disposed on the cushion cover, the zipper being fixedly connected to the cushion cover. The zipper on the cushion cover may facilitate the separation and cleaning of the cushion cover and the cushion core.

The present invention has the following beneficial effects: the cushion cover wraps the cushion core, the breathable layer may be directly washed, and an air micro-circulation is formed through an internal structure; an air micro-circulation may be likewise formed through an internal structure of the micro-circulation layer, and the breathable layer and the micro-circulation layer may co-form an air micro-circulation, thus increasing the breathability of the cushion core; and furthermore, different numbers of micro-circulation layers may be selected according to the requirements of different people, and different numbers of micro-circulation layers may also be selected according to different temperatures.

### BRIEF DESCRIPTION OF THE DRAWINGS

FIG. 1 is a schematic diagram of a plane structure according to the present invention;

FIG. 2 is a schematic diagram of an internal structure according to the present invention;

FIG. 3 is a schematic diagram of an internal structure with a base layer.

1. Cushion cover; 2. cushion core; 3. zipper; 21. base layer; 22. micro-circulation layer; 23. breathable layer.

### DETAILED DESCRIPTION OF THE INVENTION

The technical schemes of the present invention are further illustrated below in conjunction with the specific embodiments and the drawings.

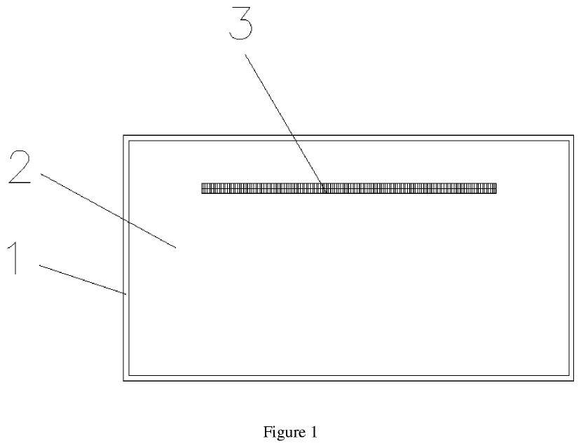

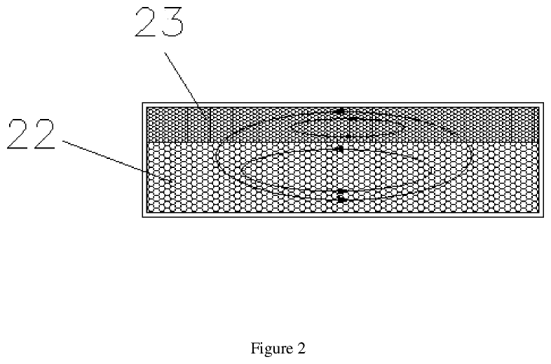

Embodiment 1: Micro-circulation breathable cushion (see FIGS. 1, 2). It includes a cushion cover 1 and a cushion core 2. The cushion core 2 includes a breathable layer 23. A micro-circulation layer 22 is disposed at a lower part of the breathable layer 23. The micro-circulation layer 22 is connected to the breathable layer 23. The density of the breathable layer 23 is in a range of 25 Kg/m³ to 85 Kg/m³. The aperture of an internal hole of the micro-circulation layer 22 is in a range of 10 ppi to 60 ppi. The density of the micro-circulation layer 23 is in a range of 0.02 g/cm³ to 0.035 g/cm³. The cushion cover 1 is made of a fiber material with a mesh structure. A zipper 3 is disposed on the cushion cover 1, the zipper 3 being fixedly connected to the cushion cover 1. The breathable layer and the micro-circulation layer of the cushion core may be fixed together by glue or other manners, and may also be only laminated together, thereby facilitating the replacement of different numbers of micro-circulation layers.

The cushion cover of the present application wraps the cushion core, the breathable layer may be directly washed, and an air micro-circulation is formed through an internal structure. An air micro-circulation may be likewise formed through an internal structure of the micro-circulation layer, and the breathable layer and the micro-circulation layer may co-form an air micro-circulation, thus increasing the breathability of the cushion core. Furthermore, different numbers of micro-circulation layers may be selected according to the requirements of different people, and different numbers of micro-circulation layers may also be selected according to different temperatures. The density of the breathable layer is controlled to be in a range of 25 Kg/m³ to 85 Kg/m³, so that the breathable layer can be directly washed and may be kept super-breathable. The aperture of the internal hole of the micro-circulation layer is kept in a range of 10 ppi to 60 ppi, and the density of the micro-circulation layer is in a range of 0.02 g/cm³ to 0.035 g/cm³, so that the micro-circulation layer can be directly washed and is super-breathable. The cushion cover is made of a fiber material with a mesh structure. The cushion cover of the cushion, made of the fiber material with the mesh structure, is good in breathability and easy to clean. The zipper on the cushion cover may facilitate the separation and cleaning of the cushion cover and the cushion core.

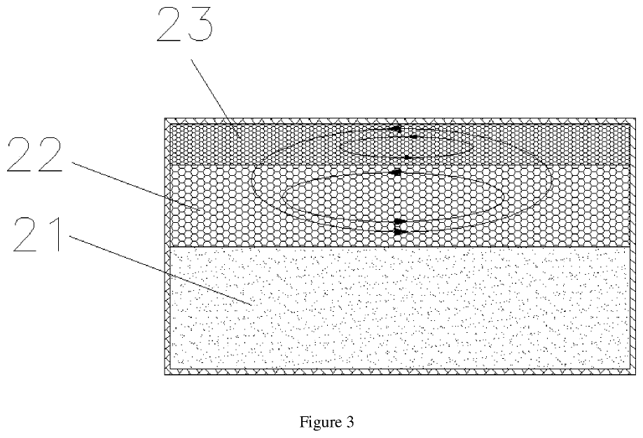

Embodiment 2: Micro-circulation breathable cushion (see FIGS. 1, 3). The difference from Embodiment 1 is that a base layer 21 is disposed below the micro-circulation layer 22, the base layer 21 being fixedly connected to the micro-circulation layer 22. Compared with the breathable layer and the micro-circulation layer, the base layer is harder for supporting. Furthermore, the base layer and the micro-circulation layer may be fixed together by glue or other manners, and may also be only laminated together, thereby facilitating the replacement of different numbers of micro-circulation layers, and also making it convenient for a user to use the base layer or not.

The foregoing specific implementation manner is used to explain the present invention, and not intended to limit the present invention. Any modifications and changes made for the present invention within the spirit of the present invention and the scope of claims fall within the scope of protection of the present invention.

1. A micro-circulation breathable cushion, comprising a cushion cover and a cushion core, the cushion core comprising a breathable layer, at least one micro-circulation layer being disposed at a lower part of the breathable layer, and the micro-circulation layer being connected to the breathable layer.

2. The micro-circulation breathable cushion of claim 1, wherein the density of the breathable layer is in a range of 25 Kg/m³ to 85 Kg/m³.

3. The micro-circulation breathable cushion of claim 1, wherein the aperture of an internal hole of the micro-circulation layer is in a range of 10 ppi to 60 ppi.

4. The micro-circulation breathable cushion of claim 3, wherein the density of the micro-circulation layer is in a range of 0.02 g/cm³ to 0.035 g/cm³.

5. The micro-circulation breathable cushion of claim 1, wherein the micro-circulation layer is fixedly connected to the breathable layer.

6. The micro-circulation breathable cushion of claim 1, wherein the micro-circulation layer is movably connected to the breathable layer.

7. The micro-circulation breathable cushion of claim 1, wherein a base layer is disposed below the micro-circulation layer, the base layer being fixedly connected to the micro-circulation layer.

8. The micro-circulation breathable cushion of claim 1, wherein a base layer is disposed below the micro-circulation layer, the base layer being movably connected to the micro-circulation layer.

9. The micro-circulation breathable cushion of claim 1, wherein the cushion cover is made of a fiber material with a mesh structure.

10. The micro-circulation breathable cushion of claim 1, wherein a zipper is disposed on the cushion cover, the zipper being fixedly connected to the cushion cover.
